(19) United States
(12) Patent Application Publication
(10) Pub. No.: US 2012/0261852 A1
(43) Pub. Date: Oct. 18, 2012

(54) WINDOW COVERING COMPONENT MANUFACTURING SYSTEMS, METHODS, AND APPARATUSES

(76) Inventors: Gordon L. King, Queen Creek, AZ (US); Don A. Patterson, Gilbert, AZ (US)

(21) Appl. No.: 13/085,474

(22) Filed: Apr. 12, 2011

(51) Int. Cl. B29C 65/00; B29C 44/46

(52) U.S. Cl. 264/46.5; 425/4 C

(57) ABSTRACT

Exemplary window covering component manufacturing systems, methods, and apparatuses are described herein. An exemplary window covering component manufacturing method includes 1) feeding two separate opposing surface sheets through a sizing channel space formed between opposing sizing elements, 2) depositing foam forming chemicals between the two separate opposing surface sheets before entry of the two separate opposing surface sheets into the sizing channel space, and 3) facilitating at least one reaction of the foam forming chemicals to form a foam material that expands in volume within the sizing channel space to press the two separate opposing surface sheets against the opposing sizing elements and then cures to form a rigid core disposed between and bonded to the two separate opposing surface sheets. Other exemplary window covering component manufacturing systems, methods, and apparatuses are also described herein.

### BACKGROUND

Window coverings such as blinds and shutters are used to cover windows or other structural openings. One popular window covering known as a “Venetian” blind includes a series of spaced apart, horizontally oriented, parallel slats assembled such that that they may be rotated, retracted, and/or extended to control privacy and/or the amount of sunlight that enters a room.

Certain characteristics are desirable for a Venetian blind slat to function satisfactorily. In order to exhibit these characteristics, a Venetian blind slat is typically constructed of one or more materials that are rigid (e.g., sufficiently rigid to maintain horizontal orientation of the slat without sagging over time), resistant to degradation or discoloration that may be caused by ultraviolet light, lightweight (e.g., lightweight enough to enable aesthetically appealing design, cost-effective installation, and convenient operation), and decorative.

The cost of manufacturing Venetian blind slats is another important factor in the selection of materials and processes to be used to make the slats. A manufacturer who is able to manufacture slats at a low cost without sacrificing quality (e.g., without sacrificing rigidity, durability, decorative appeal, etc.) may obtain a competitive advantage in the window covering industry.

In a conventional process of manufacturing traditional wood Venetian blind slats, wood (e.g., bass wood) is milled into slats that are then finished. In a conventional process of manufacturing traditional faux wood Venetian blind slats, polyvinyl chloride (PVC) or polystyrene is extruded into slats to which a decorative surface is applied. These processes, however, have drawbacks. Traditional bass wood is becoming more difficult and costly to procure, and the costs of PVC are dependent on the costs of oil, with the costs of PVC rising due to the rising costs of oil. In addition, each process is discrete and requires significant manual labor or equipment costs. Moreover, the substrate material is limited to a material that is able to be extruded or milled and cut into slats. Despite the costs of the substrate materials, the costs associated with extrusion of PVC or polystyrene slats, and the waste that results from milling wood slats, the lack of a suitable alternative has led manufacturers to continue to use conventional manufacturing processes and traditional substrate materials such as PVC and bass wood even though such processes and/or materials are not desirable for many reasons.

Processes for manufacturing foam-based window covering parts have also been introduced. However, such existing processes and parts made by the processes have shortcomings and/or limited application or use. For example, parts made using existing processes typically lack sufficient rigidity for use as a Venetian blind slat, resistance to degradation or discoloration that may be caused by ultraviolet light, or decorative appeal. Existing processes for manufacturing foam-based window covering parts are also lacking in efficiency and cost-effectiveness. For example, such existing processes are typically limited to one-up processes that produce one window covering part at a time. As another example, such existing processes typically require that a foam material be injected into a fully-enclosed or nearly fully-enclosed cavity, which limits the applicability, variability, scalability, efficiency, and/or cost-effectiveness of the processes.

### BRIEF DESCRIPTION OF THE DRAWINGS

The accompanying drawings illustrate various embodiments of the principles described herein and are a part of the specification. The illustrated embodiments are merely examples and do not limit the scope of the disclosure or the claims.

FIG. 1 is a block diagram illustrating an exemplary window covering component manufacturing system, according to principles described herein.

FIG. 2 is a side view of an exemplary implementation of the system of FIG. 1, according to principles described herein.

FIG. 3A is a side view of a portion of the exemplary implementation shown in FIG. 2, according to principles described herein.

FIGS. 3B-3C are cut-away top views of a segment of the implementation shown in FIG. 2, according to principles described herein.

FIG. 4 is a side view of another exemplary implementation of the system of FIG. 1, according to principles described herein.

FIG. 5 is a side view of another exemplary implementation of the system of FIG. 1, according to principles described herein.

FIG. 6 is a side view of another exemplary implementation of the system of FIG. 1, according to principles described herein.

FIG. 7 is a side view of another exemplary implementation of the system of FIG. 1, according to principles described herein.

FIG. 8 illustrates an exemplary window covering component manufacturing method, according to principles described herein.

FIG. 9 is a side view of a segment of an exemplary product having a rigid foam core disposed between and bonded to opposing surface sheets, according to principles described herein.

FIG. 10 illustrates an exemplary window covering apparatus, according to principles described herein.

### DETAILED DESCRIPTION

Exemplary window covering component manufacturing systems, methods, and apparatuses are disclosed. The exemplary window covering component manufacturing system, methods, and apparatuses disclosed herein provide improved scalability, efficiency, range of variability, range of applicability, and/or cost-effectiveness compared to conventional window covering component manufacturing systems. As an example, one or more of the disclosed systems, methods, and apparatuses provide for a scalable “multi-up” manufacturing capable of concurrently producing multiple window covering components (e.g., Venetian blind slats, louvers, or other generally linear window covering components). These and/or other benefits and/or improvements provided by the exemplary window covering component manufacturing system, methods, and apparatuses disclosed herein will be apparent from the following description.

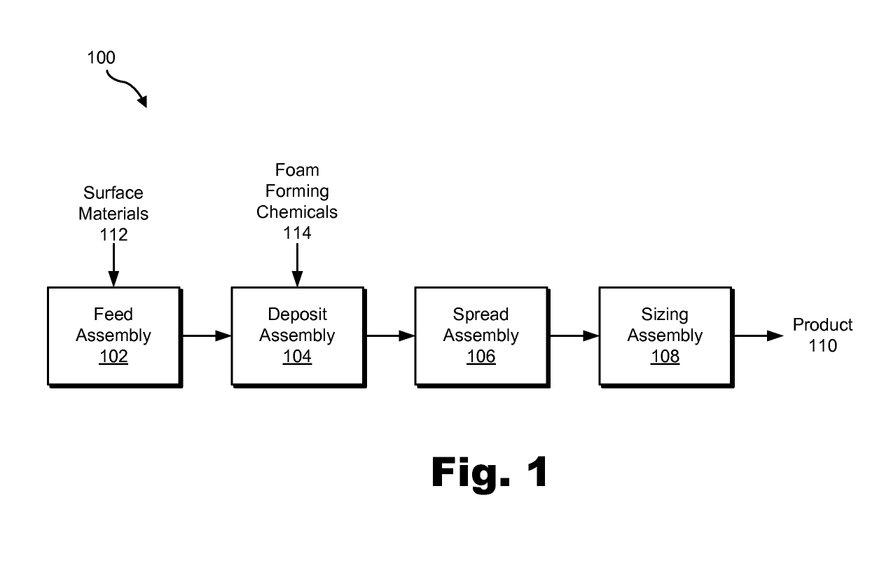

Turning now to the drawings, FIG. 1 illustrates an exemplary window covering component manufacturing system 100 (“system 100”). As shown, system 100 may include a feed assembly 102, a deposit assembly 104, a spread assembly 106, and a sizing assembly 108, which may be configured to function to produce a product 110 out of surface materials 112 and foam forming chemicals 114.

Product 110 may include a generally planar-shaped and/or linear-shaped product having a cured, generally planar, rigid foam core formed by foam forming chemicals 114 and disposed between and bonded to opposing surface materials 112. For example, the rigid foam core may be disposed between and bonded to surface materials comprising two distinct and separate opposing surface sheets, a bottom surface sheet and a top surface sheet separated by and bonded to opposite surfaces of the rigid foam core. In some examples, the two separate opposing surface sheets may form open side edges of product 110, which open side edges may expose the rigid core. In some examples, product 110 may be produced to have a predetermined width that sufficiently wide to be cut longitudinally into multiple window covering components (e.g., multiple Venetian blind slats, louvers, or other generally linear window covering components).

Product 110 may have one or more characteristics that make it desirable for use as one or more window covering components such as one or more Venetian blind slats, louvers, or other generally linear window covering components. For example, product 110 may be rigid (e.g., sufficiently rigid to maintain horizontal orientation of product 110 without sagging over time), resistant to degradation or discoloration that may be caused by ultraviolet light, lightweight (e.g., lightweight enough to enable aesthetically appealing design, cost-effective installation, and convenient operation), and/or decorative. Product 110 may be more lightweight and/or less dense than conventional Venetian blind slats, which may facilitate more aesthetically appealing design, cost-effective installation, and/or convenient operation as compared to conventional Venetian blind slats. For example, the decreased weight and/or density of product 110 as compared to a conventional blind slat may allow ladders that support blind slats in a Venetian blind assembly to be spaced farther apart than in a Venetian blind assembly that includes conventional slats. In some examples, the systems, methods, and apparatuses disclosed herein may produce a product 110 having an overall density that is within a range of approximately two pounds per cubic foot to twenty-six pounds per cubic foot (2-26 lbs per ft³).

Surface materials 112 may include, without limitation, paper, wood, wood veneers, thermo-plastic sheets or films comprised of PVC, polypropylene, PETG, Mylar, foils, or other suitable materials. Surface materials 112 may be finished, decorative, unfinished, or partially finished (e.g., an outer surface is finished and an opposite inner surface is unfinished). As used herein, the term “finished surface” refers to a surface that is considered satisfactory and desirable in the window covering industry for use as an exposed outer surface of a window covering component. To illustrate, a wood veneer may have a finished surface that is satisfactory and desirable for use as an exposed outer surface of a window covering component. In some examples in which surface materials 112 include surface sheets having finished surfaces, product 110 may be partially finished in that a bottom surface and a top surface of product 110 may be finished while side edges of product 110 are unfinished. In other examples in which surface materials 112 include surface sheets having unfinished surfaces, product 110 may be unfinished in that a bottom surface, a top surface, and side edges of product 110 are unfinished. Such an unfinished product 110 may be finished in any suitable way, including, without limitation, by cutting, painting, and/or coating product 110.

Foam forming chemicals 114 may include chemicals (e.g., liquid chemicals or a combination of liquid and powder chemicals) configured to react to form a foam material that expands in volume and then cures to form a rigid foam material. Examples of foam forming chemicals 114 include, without limitation, mixtures of a catalyst and a polymer system. Examples of polymer systems include, without limitation, one or more polymers, polyols, polyurethanes, polyesters, phenolics, polystyrenes, epoxies, latexes, rubbers, microcellular foams, thermosets, thermoplastics, or combinations or sub-combinations thereof. Polymer systems may also include other materials such as modifiers and/or fillers (e.g., titanium dioxide (TiO2), calcium, pumice, wood, dust, and fiber (hard or soft)). For example, a polymer system may include a filler such as a wood filler mixed with one or more polymers in any suitable ratio. Examples of catalysts include, without limitation, one or more curing agents, solvents, water, isocyanates, or combinations of sub-combinations thereof. Isocyanates may include, without limitation, one or more diisocyanates such as methylenebis (phenyl isocyanate) (MDI), toluene diisocyanate (TDI), hexamethylene diisocyanate (HDI), naphthalene diisocyanate (NDI), methylene bis-cyclohexylisocyanate (hydrogenated MDI) (HMDI), isophorone diisocyanate (IPDI), and polyisocyanates such as HDI biuret and HDI isocyanurate. Examples of foam materials that may be formed by a reaction of foam forming chemicals 114 may include, without limitation, urethane foam, polyurethane foam, polyester foam, phenolic foam, styrene foam, thermosetting foam (e.g., a thermosetting hybrid foam), non-thermosetting foam, thermoplastic foam, and a foam (e.g., a urethane foam) cross-linked to a thermosetting material inasmuch as the resultant cross-linked foam material is capable of expanding in volume and bonding to surface materials 112 as described herein. All forms of foam may include organic or in-organic fillers.

In certain implementations, the polymer system is in liquid form, and the catalyst to be mixed with the polymer system is in liquid, powder, or other suitable form. When mixed together, the chemicals are in liquid form ready to be deposited or otherwise applied in a manufacturing process in any of the ways described herein.

Foam forming chemicals 114 react to form a foam material that expands in volume and then cures to form a rigid foam material in response to any suitable trigger or triggers. As an example, such reaction or reactions may be triggered by time. For instance, a reaction of foam forming chemicals 114 may be configured to begin a predetermined length of time after the foam forming chemicals 114 are mixed together. Additionally or alternatively, in some examples, one or more reactions of foam forming chemicals 114 may be triggered by application of at least one of temperature (e.g., by application of heat or cold such as by heating or cooling one or both sizing elements 206), light waves (e.g., by application of ultraviolet light at beginning of sizing elements 206), moisture (e.g., by application of mist or other moisture at beginning of sizing elements 206), friction, an electron beam, and any other suitable trigger.

The foam material formed by a reaction of the foam forming chemicals 114 may be configured to expand in volume such that the density of the foam material generally decreases and is significantly less than the pre-reaction density of foam forming chemicals 114.

The foam material formed by a reaction of the foam forming chemicals 114 may be configured to expand in volume and bond with surface materials 112 during a manufacturing process, such as any of the exemplary manufacturing processes described here. In certain implementations, the foam material formed by the form forming chemicals 114 may bond with surface materials 112 by penetrating and curing to form a rigid foam within at least part of the surface materials 112. In certain implementations, foam forming chemicals 114 may have an adhesive characteristic, which, in addition or alternative to penetration and curing type bonding, may facilitate adhesive type bonding of the foam material formed by the form forming chemicals 114 with surface materials 112.

Different surface materials 112 may have different characteristics that affect bonding of the foam material to the surface materials 112. For example, certain surface materials 112 may allow the foam material to penetrate all the way through the surface materials, other surface materials 112 may allow the foam material to penetrate only partially into the surface materials, and other surface materials 112 may not allow the foam material to gain significant penetration within the surface materials 112. In some applications, surface materials 112 that allow partial penetration of the foam material may support penetration and curing type bonding with the foam material while also being able to provide an outer surface that is not compromised by penetration of the foam material. Such an outer surface may be suitable as a finished surface of a window covering component.

Feed assembly 102 may include one or more mechanisms configured to feed one or more materials such as surface materials 112 along a path by and/or through deposit assembly 104, spread assembly 106, and sizing assembly 108. Any suitable feed mechanisms may be employed, including pull and/or push feed mechanisms. Feed assembly 102 may be configured to feed materials as any suitable feed rate, which rate may be adjustable by a user of system 100. In some examples, the rate at which surface materials 112 are fed by feed assembly 102 may be within a range two feet per minute to two hundred feet per minute (2-200 ft per minute). Exemplary implementations of feed assembly 102 are described herein.

Deposit assembly 104 may include one or more mechanisms configured to deposit foam forming chemicals 114 onto one or more surface materials 112 as the surface materials 112 pass by deposit assembly 104 before entry of the surface materials 112 into spread assembly 106 and/or sizing assembly 108. For example, deposit assembly 104 may deposit liquid chemicals configured to react to form a foam material onto one or more surface materials 112 before the surface materials 112 reach spread assembly 106 and/or sizing assembly 108. Deposit assembly 104 may include any mechanisms suitable for depositing chemicals 114 onto a surface. For example, deposit assembly 104 may include, without limitation, one or more chemical reservoirs, chemical mixers, nozzles, dispensers, sprayers, printers, etc. Exemplary implementations of deposit assembly 104 are described herein.

Spread assembly 106 may be configured to spread foam forming chemicals 114 before the foam forming chemicals 114 reach sizing assembly 108. For example, spread assembly 106 may be configured to allow and/or force foam forming chemicals to spread widthwise before reaching sizing assembly 108. In certain implementations, spread assembly 106 may include one or more elements that are separate from deposit assembly 104. In other implementations, spread assembly 106 and deposit assembly 104 may include integrated elements (e.g., liquid sprayer(s) or printer(s)) that deposit foam forming chemicals 114 such that the foam forming chemicals 114 are spread out to a suitable predetermined width as they are deposited onto one or more surface materials 112. In such implementations, a separate spread assembly 106 may be omitted. Exemplary implementations of spread assembly 106 are described herein.

Sizing assembly 108 may be configured to allow and/or facilitate one or more reactions of foam forming chemicals 114 such that the foam forming chemicals 114 form a foam material that expands in volume and cures to form a rigid foam core disposed between and bonded to surface materials 112. In certain implementations, sizing assembly 108 may include one or more elements positioned to control the extent to which the thickness of the foam material is allowed to expand before the foam materials cures to form a rigid core between surface materials 112. Exemplary implementations of sizing assembly 108 are described herein.

Exemplary implementations of system 100 will now be described.

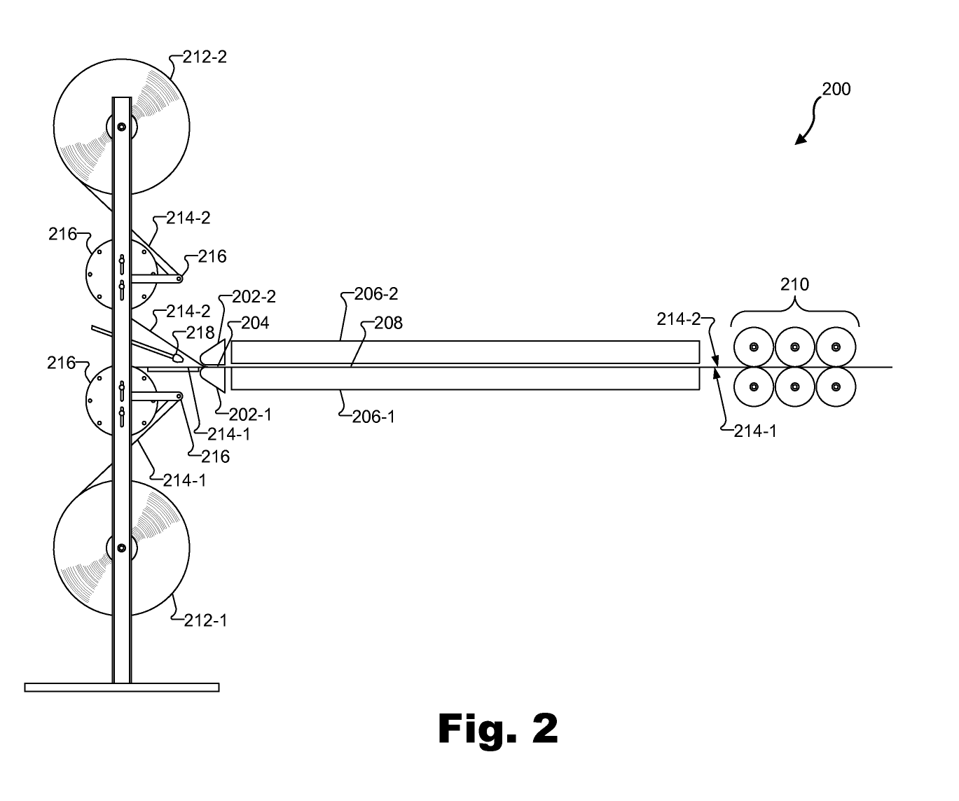

FIG. 2 is a side view of an exemplary implementation 200 of system 100. In implementation 200, spread assembly 106 includes two opposing metering elements including a lower metering element 202-1 and an upper metering element 202-2 (collectively “metering elements 202”) positioned to form a metering channel space 204 (also referred to as “first channel space 204” herein) between and separating the metering elements 202. First channel space 204 may have a first thickness (i.e., height) equal to the distance between the top surface of lower metering element 202-1 and the bottom surface of upper metering element 202-2.

In implementation 200, sizing assembly 108 includes two opposing sizing elements including a lower sizing element 206-1 and an upper sizing element 206-2 (collectively “sizing elements 206”) positioned to form a sizing channel space 208 (also referred to as “second channel space 208” herein) between the sizing elements 206. Second channel space 208 may have a second thickness (i.e., height) equal to the distance between the top surface of lower sizing element 206-1 and the bottom surface of upper metering element 206-2.

The first thickness of first channel space 204 is less than the second thickness of second channel space 208. As described herein, such a configuration allows room for liquid chemicals 114 to react in second channel space 208 to form a foam material that has room to expand in volume, including in thickness to fill the thickness of the second channel space 208. In an exemplary embodiment, the thickness of first channel space 204 is approximately sixty thousandths of an inch and the thickness of second channel space 208 is approximately one hundred thirty five thousandths of an inch, which allows space for the thickness of the foam material to expand seventy five thousands of an inch in thickness after exiting first channel space 204.

Metering elements 202 and sizing elements 206 may be made of any material or materials suitable for the functions of metering elements 202 and sizing elements 206 described herein. For example, metering elements 202 and sizing elements 206 may be made of metal, wood, and/or other suitable materials. Sizing elements 206 may be of any suitable size. In an exemplary embodiment, each of sizing elements 206 is approximately eight feet long by seventeen inches wide. In another exemplary embodiment, each of sizing elements 206 is approximately twelve to eighteen feet long by thirty inches wide. Other suitable sizes may be employed in other embodiments.

In implementation 200, feed assembly 102 includes a pull-feed mechanism in the form of one or more pulling rollers 210 configured to pull materials (e.g., surface materials 112 or product 110 produced by implementation 200) after the materials exit second channel space 208. Feed assembly 102 further includes a first supply roll 212-1 and a second supply roll 212-2 (collectively “supply rolls 212”) from which a first surface sheet 214-1 and a second surface sheet 214-2 (collectively “surface sheets 214”), respectively, may be pulled by pulling rollers 210. As illustrated, surface sheets 214 may be pulled off of respective supply rolls 212, around respective guide cylinders 216, into and through first channel space 204, and into and through second channel space 208. The direction that surface sheets 214 are fed through first channel space 204 and second channel space 208 may be referred to as a “longitudinal” direction herein. The longitudinal direction runs along a longitudinal axis of implementation 200. Thus, when surface sheets 214 are within first channel space 204 and second channel space 208, the surface sheets 214 are substantially parallel to the channel spaces 204 and 208 and to the longitudinal axis of implementation 200.

Pulling rollers 210 may be configured to pull materials of various thicknesses and/or widths. For example, pulling rollers 210 may be tensioned toward one another to be able to establish sufficient pulling friction on materials having any suitable thickness. The tension may be configured to allow pulling rollers 210 to begin pulling opposing surface sheets 214 not having any core foam material disposed between them in order to begin a manufacturing process.

Surface sheets 214 may comprise any of the exemplary surface materials listed herein. Surface sheets 214 may have any suitable thicknesses. In an exemplary embodiments, surface sheets 214 that are each approximately ten thousandths of an inch thick are used. Other surface sheets 214 having other suitable thicknesses may be used in other embodiments.

As surface sheets 214 are pulled off of supply rolls 212 and toward first channel space 204, the surface sheets 214 converge as shown in FIG. 2 such that they become opposing surface sheets 214 with a surface of first surface sheet 214-1 facing a surface of second surface sheet 214-2 by the point of entry of surface sheets 214 into first channel space 204. In implementation 200, the top surface of bottom surface sheet 214-1 faces the bottom surface of top surface sheet 214-2.

In implementation 200, deposit assembly 104 includes a liquid chemical depositing nozzle 218 configured to deposit a stream of foam forming liquid chemicals 114 between opposing surface sheets 214. In the illustrated example, nozzle 218 is configured to deposit a stream of foam forming liquid chemicals 114 onto a surface of first surface sheet 214-1 (e.g., the top surface of the bottom surface sheet 214-1) as first surface sheet 214-1 passes by nozzle 218 and before entry of the surface sheets 214 into first channel space 204.

Deposit assembly 104 may also include one or more chemical reservoirs (not shown) configured to store and feed foam forming chemicals 114 into nozzle 218. In an exemplary embodiment, two or more chemicals 114 (e.g., an isocyanate) and a polyol) may be provided from two or more separate reservoirs for mixing within nozzle 218. When mixed within nozzle 218, the chemicals 114 may begin at least one reaction or become poised to begin at least one reaction in which the chemicals 114 react to form a foam material (e.g., a polyurethane foam) that expands in volume and then cures to form a rigid foam core disposed between and bonded to surface sheets 214.

The reaction of chemicals 114 may be triggered in any of the ways described herein. To illustrate, chemicals 114 may be configured to begin a reaction a predetermined length of time after the chemicals 114 are mixed together in nozzle 218. Accordingly, the chemicals 114 may remain in a liquid state for the predetermined length of time, at which time the chemicals 114 may react to form a foam material that expands in volume and then cures to form a rigid foam material. The foam forming chemicals 114 may be tailored to produce a well-timed reaction process. In an exemplary embodiment, for example, the foam forming chemicals 114 may be configured to remain in liquid form until after the deposited foam forming chemicals 114 have passed through first channel space 204, which allows metering elements 202 to force the liquid chemicals 114 to spread widthwise to a predetermined width. The foam forming chemicals 114 may be configured to react, after the foam forming chemicals 114 have entered into second channel space 208, to form a foam material that expands within second channel space 208 and the cures to form a rigid core material bonded to surface sheets 214 within second channel space 208. In an exemplary embodiment, the feed rate of surface sheets 214 may be configured such that deposited foam forming liquid chemicals 114 pass through first channel space 204 between approximately two to five second (2-5 seconds) after the chemicals 114 mix in nozzle 218 and then begin a reaction to start forming a foam material between approximately two to three seconds (2-3 seconds) after passing through first channel space 204.

FIG. 2 illustrates an exemplary configuration of implementation 200 prior to initiation of a continuous manufacturing process. As shown, surface sheets 214 are position such that pulling rollers 210 may begin pulling the surface sheets 214 off of supply rolls 212 and along respective paths past nozzle 218 and through first channel space 204 and second channel space 208. Pulling rollers 210 may be driven to pull surface sheets 214 at any feed rate that is suitable for a manufacturing process performed by implementation 200.

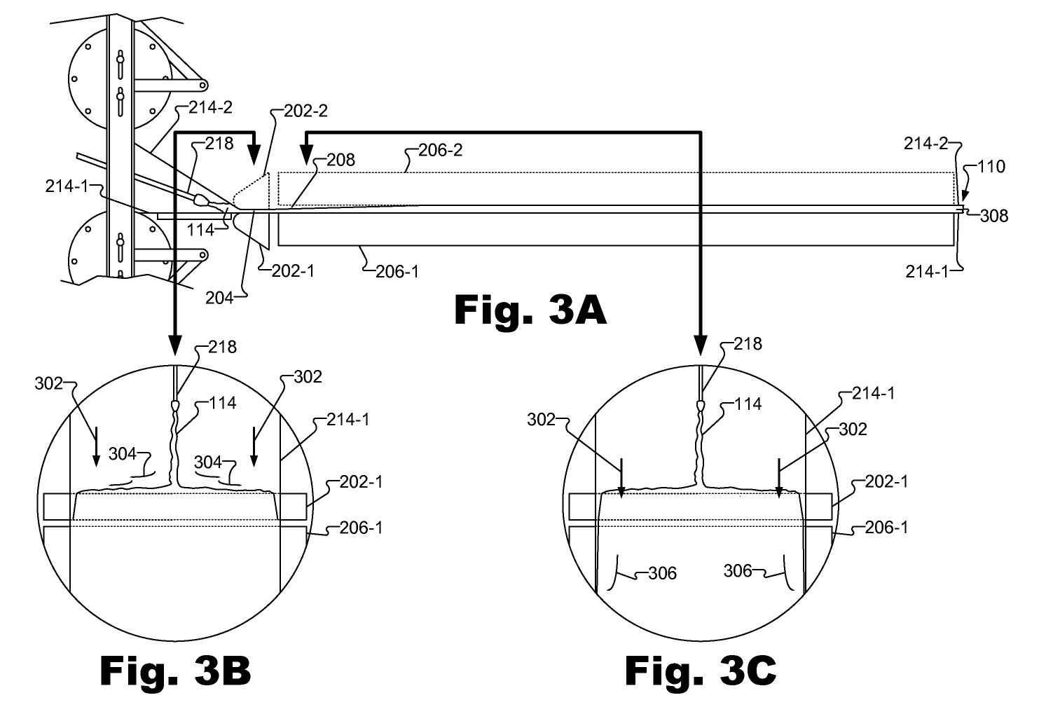

As surface sheets 214 are fed through implementation 200 at a suitable feed rate, nozzle 218 may deposit a stream of foam forming chemicals 114 on first surface sheet 214-1 before the surface sheets 214 enter into first channel space 204. FIG. 3A is a side view of a portion of implementation 200 at a particular point in a manufacturing process being performed by implementation 200. As shown, nozzle 218 deposits a stream of liquid chemicals 114 between opposing surface sheets 214 before the surface sheets 214 enter into first channel space 204.

As the manufacturing process continues, the deposited liquid chemicals 114 and opposing surface sheets 214 enter reach first channel space 204. At first channel space 204, the liquid chemicals 114 are forced to spread out on one or both surface sheets 214 in a widthwise direction. As the manufacturing process continues, the spread liquid chemicals 114 exit first channel space 204 and enter into second channel space 208. While in the second channel space 208, the spread liquid chemicals 114 react to form a foam material that expands in volume, which expansion increases the thickness of the foam material and presses surface sheets 214 against respective sizing elements 206. FIG. 3A depicts the thickness of the foam material increasing as the foam material and surface sheets 214 move farther along the path through second channel space 208. In particular, upper surface sheet 214-2 is pressed upward until it presses against upper sizing element 206-2. With surface sheets 214 pressed against respective sizing elements 206, the foam material cures to form a rigid foam core disposed between and bonded to the surface sheets 214 to form product 110 that exits from second channel space 208.

FIGS. 3B-3C are cut-away top views of a segment of implementation 200 and illustrate exemplary widthwise spreading of liquid chemicals 114 and expansion of the foam material formed by a reaction of the liquid chemicals 114 at different points in a continuous manufacturing process performed by implementation 200. In FIG. 3A, upper metering element 202-2 and upper sizing element 206-2 are depicted with dashed lines to represent that upper metering element 202-2 and upper sizing element 206-2 are removed from the cut-away top views shown in FIGS. 3B-3C. Upper surface sheet 214-2 is also removed from the cut-away top views shown in FIGS. 3B-3C.

The segment of implementation 200 illustrated in FIGS. 3B-3C includes nozzle 218, metering elements 202 (bottom metering element 202-1 is shown), and part of sizing elements 206 (part of bottom sizing element 206-1 is shown). Arrows 302 represent longitudinal movement of surface sheets 214 (bottom surface sheet 214-1 is shown) relative to the segment (e.g., relative to nozzle 218, metering element 202-1, and sizing element 206-1) as the surface sheets 214 are fed through the segment.

As surface sheets 214 pass by nozzle 218, nozzle 218 deposits a stream of liquid chemicals 114 onto bottom surface sheet 214-1. The deposited liquid chemicals 114 move toward metering elements 202, which are configured to force the liquid chemicals 114 to spread widthwise. Arrows 304 represent widthwise spreading of the liquid chemicals 114 at first channel space 204 formed by metering elements 202. The thickness of first channel space 204 may be configured to force the widthwise spreading of the liquid chemicals 114 at first channel space 204. In some examples, the thickness (i.e., height) of the stream of liquid chemicals 114 deposited on the bottom surface sheet 2014-1 may be greater than the thickness of the first channel space 204 such that the thickness of the first channel space 204 will limit the thickness of the liquid chemicals 114 that can pass through first channel space 204 and thereby force the deposited liquid chemicals 114 to spread widthwise until the thickness of the deposited liquid chemicals is reduced to a thickness that can pass through first channel space 204.

The exemplary pattern of widthwise spreading of liquid chemicals 114 at first channel space 204 shown in FIG. 3B is illustrative only. Other suitable patterns of widthwise spreading may be allowed and/or forced in other implementations or examples.

The extent to which the liquid chemicals 114 are spread widthwise by metering elements 202 may be controlled by one or more settings of implementation 200. For example, at least one of the thickness of first channel space 204, the rate at which the liquid chemicals 114 are deposited by nozzle 218, and the rate at which surface sheets 214 are fed through first channel space 204 may be set to determine, at least in part, the extent to which the liquid chemicals 114 will spread widthwise such that the liquid chemicals 114 will be consistently spread to a predetermined width by metering elements 202. One or more of these settings may be adjusted by a user of implementation as may suit a particular manufacturing process, application, or width of surface sheets 214. Accordingly, implementation 200 may be configured to accommodate surface sheets 214 of various widths and/or to produce a product 110 of various widths at least because the thickness of first channel space 204, the rate at which the liquid chemicals 114 are deposited by nozzle 218, and/or the rate at which surface sheets 214 are fed through first channel space 204 may be set or adjusted such that the liquid chemicals 114 will be spread widthwise to a predetermined width that is appropriate for the width of the surface sheets 214 being used.

As surface sheets 214 continue to move in a longitudinal direction as indicated by arrows 302, the spread liquid chemicals 114 exit first channel space 204 and then enter into second channel space 208, which has a thickness that is greater than the thickness of the first channel space 204. While in second channel space 208, the liquid chemicals 114 react to form a foam material that expands in volume within the second channel space 208. The foam material may expand in thickness (i.e., height) as shown in FIG. 3A. In addition, the foam material may expand widthwise as represented by arrows 306 in FIG. 3C. In certain examples, the widthwise expansion of the foam material in second channel space 208 is very small and/or nominal compared to the widthwise expansion of the liquid chemicals 114 at first channel space 204.

Foam forming chemicals 114 may be configured such that the foam material formed by the foam forming chemicals 114 will expand in volume by a predetermined amount. Accordingly, the chemicals 114 may be tailored such that the foam material will expand to fill the thickness of second channel space 208. In certain examples, the chemicals 114 may be tailored such that the foam material would expand to a predetermined thickness slightly greater than the thickness of second channel space 208 if not restricted by sizing elements 206. Accordingly, the foam material will expand in thickness to press surface sheets 214 against their respective metering elements 206.

The expanded foam material may be configured to cure within second channel space 208 to form a rigid core material disposed between and bonded to opposing surface sheets 214, i.e., product 110 having a thickness that is equal to the thickness of second channel space 208. The chemicals 114 may be configured to form a rigid core material having a level of rigidness that is suitable for a particular application or use of product 110. The bond between the rigid core material and surface sheets 214 may be formed in any suitable way, including by the foamed material penetrating and curing within at least part of surface sheets 214, by the foamed material having an adhesive characteristic that causes the foamed material to adhere to surface sheets 214, and/or by any other suitable bond.

The curing of the foam material may occur as part of the same reaction that formed the foam material from chemicals 114 (e.g., a latter stage of the reaction) or as part of a separate reaction. The curing may be triggered in any suitable way, including by any of the triggers described herein.

As shown in FIG. 3A, product 110, which includes a rigid foam core disposed between and bonded to opposing surface sheets 214, exits from second channel space 208. As shown, product 110 may include bottom surface sheet 214-1 bonded to a bottom surface of a rigid foam core 308 and a top surface sheet 21402 bonded to a top surface of rigid foam core 308 such that rigid foam core is disposed between and separated opposing surface sheets 214. The two opposing surface sheets 214 form open side edges between the two opposing surface sheets 214 of product 110. The open side edges expose the rigid foam core 308. Product 110 may be continuously manufactured by implementation 200 performing a continuous manufacturing process as described herein.

The thickness of second channel space 208 may be adjusted by a user of implementation 200 such that implementation 200 may produce product 110 having a predetermined thickness. Accordingly, implementation 200 may be used to produce products of various predetermined thicknesses.

Additionally or alternatively, implementation 200 may be used to produce products of various widths. As mentioned, implementation 200 may be configured to force chemicals 114 to spread to a variety of predetermined widths. In addition, implementation 200 may be configured to accommodate surface sheets 214 of various widths. FIGS. 3B-3C illustrate surface sheet 214-1 as having a particular width that is less than the width of bottom metering element 202-1 and bottom sizing element 206-1. Implementation 200 may similarly accommodate surface sheets 214 having other widths, including other widths that are less than the width of bottom metering element 202-1 and bottom sizing element 206-1, as well as widths that are equal to or greater than the width of bottom metering element 202-1 and bottom sizing element 206-1.

In certain examples, implementation 200 may include one or more edging mechanisms (not shown) configured to form consistent side edges of product 110. For example, one or more edge slitters or other cutting mechanisms may be disposed, at any suitable point along the path followed by product 110, including at a point where the edge slitter is able to cut product 110 as product 110 is fed through second channel space 208 of after product 110 exits second channel space 208. Each edge slitter may be configured to trim off a small side edge portion of surface sheets 214 as well as a small side edge portion of the rigid foam core 308 such that a consistent side edge having the rigid foam core 308 flush with the surface sheets 214 is formed.

In certain examples, implementation may additionally or alternatively include one or more strip slitters (not shown) or other cutting mechanisms configured to longitudinally cut product 110 into multiple longitudinally elongate strips that are configured to function as window covering components such as Venetian blind slats. Each elongate strip may be cut to any suitable length during or after the manufacturing process.

The positions of edge and/or strip slitters may be adjustable by a user of implementation 200. Accordingly, implementation 200 may be configured to edge products 110 of various widths and/or cut product 110 into multiple longitudinally elongate strips of various widths. In this manner, implementation 200 may perform a continuous “multi-up” manufacturing process that concurrently produces multiple window covering components.

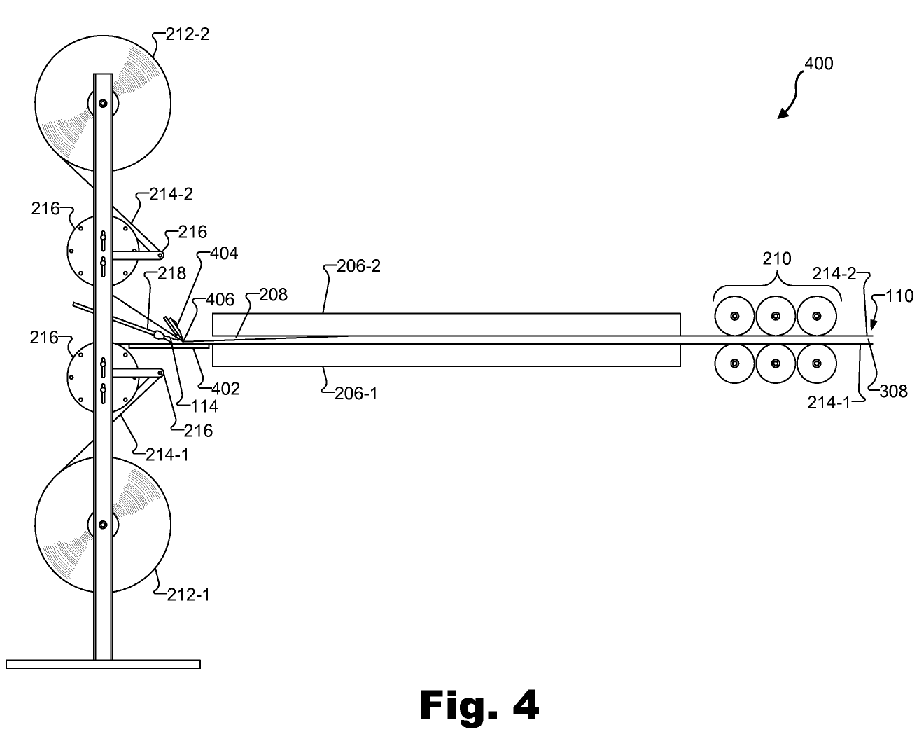

Implementation 200 is illustrative of one particular implementation of system 100. Other implementations of system 100 may be used to perform other manufacturing processes to produce product 110. FIGS. 4-7 illustrate other exemplary implementations of system 100.

Implementation 400 shown in FIG. 4 is similar to implementation 200 except that implementation 400 includes a different implementation of spread assembly 106. In implementation 200, spread assembly 106 includes opposing metering elements 202 in the form of metering blocks. In implementation 400, spread assembly 106 includes metering elements in the form of a bottom plate 402 and a blade 404 disposed above bottom plate 402 to form a metering channel space 406 (also referred to as “first channel space 406” herein) through which surface sheets 214 and deposited chemicals 114 may be fed. Bottom plate 402 and blade 404 may be configured to function similarly to metering elements 202 to spread deposited liquid chemicals 114 widthwise before entry into second channel space 208.

Implementations 200 and 400 are each configured to spread liquid chemicals 114 onto opposing surfaces of both surface sheets 214. The spreading of the liquid chemicals 114 may be uniform for both surfaces, which generally leads to equal saturation of the surface sheets 214, which in turn leads to production of a balanced product 110 that has generally congruent bonds with both surface sheets 110. This helps to prevent bowing of product 110. If saturation were not equal (i.e., one surface sheet is more saturated than another), incongruent bonds may be formed and lead to production of an imbalanced product that is conducive to bowing.

While implementations 200 and 400 illustrate exemplary embodiments of spread assembly 106, other mechanisms for spreading liquid chemicals 114 widthwise may be alternatively or additionally employed in other implementations. For example, in addition or alternative to a separate spread assembly 106, certain implementations may include a deposit assembly 104 configured to deposit liquid chemicals 114 in a manner that spreads the liquid chemicals 114 to a predetermined width. As an example, nozzle 218 may be configured to oscillate side to side at a speed configured to deposit a pattern of sufficient liquid chemicals 114 having a predetermined width. As another example, a sprayer may be employed to deposit liquid chemicals 114 by spraying a web of liquid chemicals 114 having a predetermined width. As yet another example, a print mechanism may be employed to print liquid chemicals 114 onto one or more surfaces at a predetermined width.

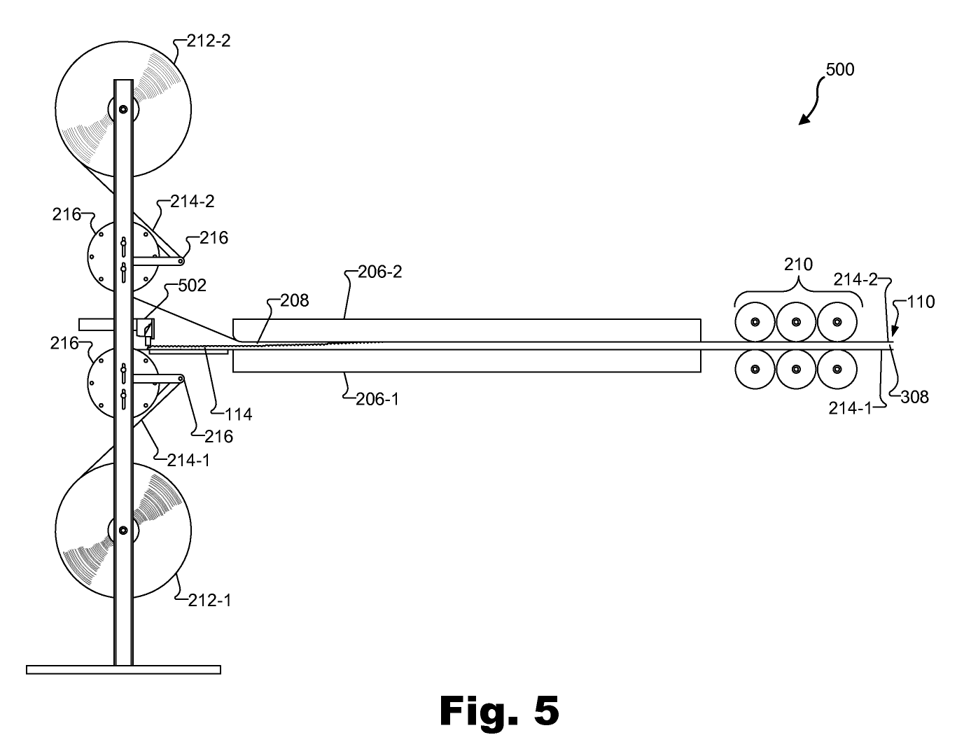

Several exemplary implementation employing one or more print mechanisms configured to deposit liquid chemicals 114 printing the liquid chemicals 114 onto one or more surfaces at a predetermined width will now be described with reference to FIGS. 5-7. In each of these exemplary implementations, the print mechanism(s) may be replaced by one or more other liquid chemical 114 deposit mechanisms capable of depositing liquid chemicals 114 at a suitable predetermined width.

Implementation 500 shown in FIG. 5 includes a print mechanism 502 configured to print foam forming liquid chemicals 114 onto an upper surface of surface sheet 214-1 before entry of surface sheets 214 into sizing channel space 208. Print mechanism 502 may employ and suitable liquid printing technologies, including, without limitation, ink printing technologies.

Print mechanism 502 may be configured to print a suitable amount of chemicals 114 onto a suitable area of surface sheet 214-1. In some examples, print mechanism 502 may include a print head configured to move (e.g., side to side) to print chemicals 114 onto a determined width of surface sheet 214-1 as surface sheet 214-1 passes by the print head. In other examples, print mechanism 502 may include a print head of sufficient width to facilitate printing of chemicals 114 onto a suitable width of surface sheet 214-1 as surface sheet 214-1 passes by the print head.

In some examples, print mechanism 502 may be user configurable to mix and print chemicals 114 onto a user-selectable area (e.g., a select width) at a user-selectable rate. Accordingly, print mechanism 502 may be adjusted to print chemicals 114 at any one of a variety of suitable widths and/or any one of a variety of suitable rates to allow for manufacture of any suitable width and/or thickness of product 110 that can be accommodated by implementation 500.

Because print mechanism 502 is able to print liquid chemicals 114 at a suitable width, implementation 500 may not force additional widthwise spreading of the liquid chemicals 114 after their deposit onto surface sheet 214-1. Accordingly, print mechanism 502 may be said to function as both deposit assembly 104 and spread assembly 106. In alternative implementations, a spread assembly 106, such as any of those described herein, may be employed in addition to print mechanism 502 to force widthwise spreading of the printed chemicals 114.

After the liquid chemicals 114 are printed onto surface sheet 214-1, the liquid chemicals 114 may react within second channel space 208 as described herein to form a foam material that expands to press surface sheets 214 against sizing elements 206 and then cures to form a rigid core disposed between and bonded to surface sheets 214, to form product 110. FIG. 5 depicts an expansion of the foam material as the foam material passes through second channel space 208, and exit of product 110 from second channel space 208.

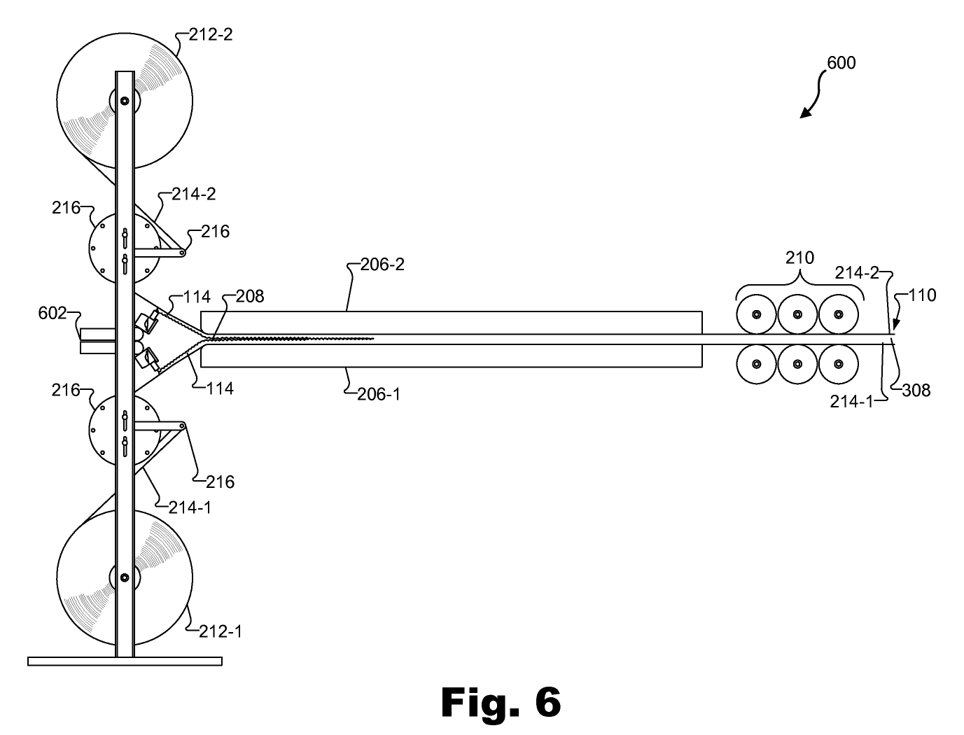

Implementation 600 shown in FIG. 6 is similar to implementation 500 except that implementation 600 includes a print mechanism 602 configured to print foam forming liquid chemicals 114 onto both surface sheet 214-1 and surface sheet 214-2. Print mechanism 602 may employ and suitable liquid printing technologies and may be configured to function as print mechanism 502 with the additional capability of being able to simultaneously print chemicals 114 onto both surface sheet 214-1 and surface sheet 214-2. For example, print mechanism 602 may include a first print head configured to print liquid chemicals 114 onto the top surface of bottom surface sheet 214-1 and a second print head configured to print liquid chemicals 114 onto the bottom surface of top surface sheet 214-2. When compared to the amount of chemicals 114 printed onto surface sheet 214-1 by print mechanism 502 in implementation 500, print mechanism 602 in implementation 600 may apply approximately the same overall amount of chemicals 114, with the first print head applying approximately half the amount of the chemicals 114 onto surface sheet 214-1 and a second print head applying approximately half the amount or rate of the chemicals 114 onto surface sheet 214-2. Other application ratios may be used in other embodiments.

After the chemicals 114 are printed onto surface sheets 214 and enter into sizing channel space 208, the chemicals 114 may react to form foam material as described herein. The printed surfaces of surface sheets 214 face one another in sizing channel space 208 such that the foam material on surface sheet 214-1 and the foam material on surface sheet 214-2 may expand to join together and to press surface sheets 214 against sizing elements 206. The expanded foam material may then cure as described herein to form product 110.

By printing (or otherwise depositing) liquid chemicals 114 onto both surface sheets 214, the exposure (e.g., surface area exposure and/or time exposure) of the liquid chemicals 114 to surface sheets 214 may be increased, which may lead to increased penetration or saturation of surface sheets 214 and formation of stronger bonds between the core material and one or more surface sheets 214. For example, because liquid chemicals 114 are applied to surface sheet 214-2 by implementation 600, the liquid chemicals 114 may have more time and/or area to penetrate into, adhere to, and/or otherwise bond with surface sheet 214-2.

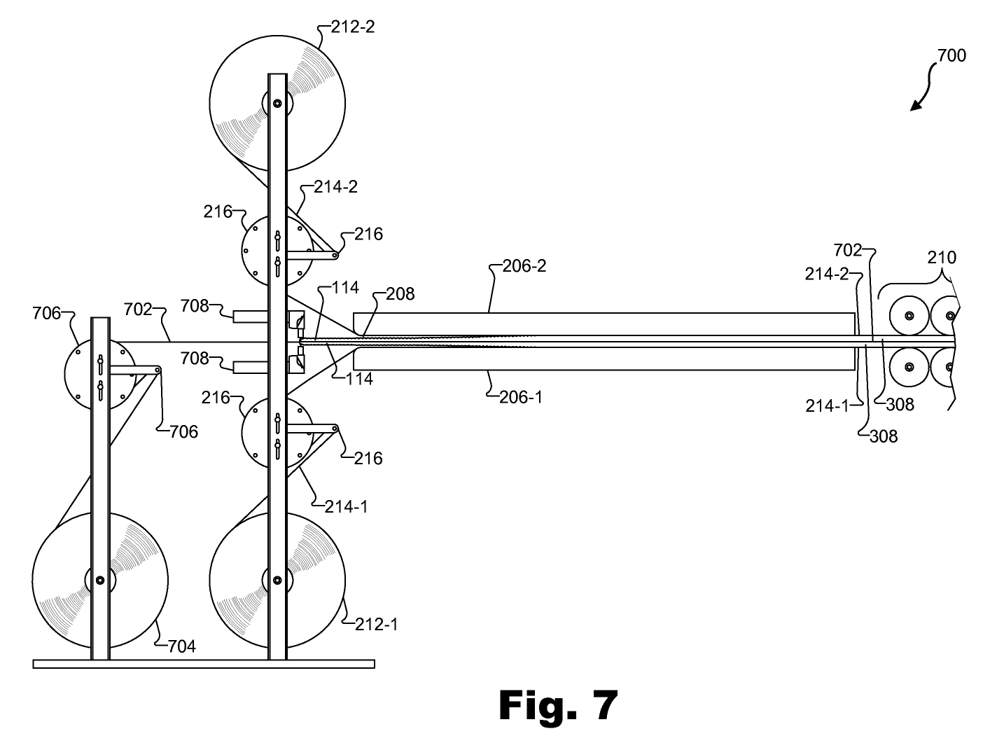

FIG. 7 illustrates another exemplary implementation 700 of system 100. As shown in FIG. 7, implementation 700 may be configured to feed an additional sheet 702 (“inner sheet 702”) concurrently with surface sheets 214-1 and 214-2 along a path through sizing channel space 208. Inner sheet 702 may be pulled from a third supply roll 704, about respective guide cylinders 706, past a print mechanism 708, and through channel space 208 by pulling rollers 210 in a configuration that disposes inner sheet 702 between surface sheets 214. Print mechanism 708 may be configured to print foam forming liquid chemicals 114 onto two opposite surfaces (i.e., bottom and top surfaces) of the inner sheet 702 before entry of the inner sheet 702 and surface sheets 214 into channel space 208 as shown in FIG. 7. For example, print mechanism 708 may include first and second print heads, with each print head configured to print liquid chemicals 114 onto one side of inner sheet 702. Print mechanism 708 may print liquid chemicals 114 onto the surfaces of inner sheet 702 in any of the ways described herein.

In some examples, inner sheet 702 may be made of the same materials as surface sheets 214. In other examples, inner sheet 702 may be made of different materials than surface sheets 214. For instance, surface sheets 702 may include one or more materials having finished surfaces, and inner sheet 702 may consist of one or more materials having unfinished surfaces.

After the printed liquid chemicals 114 have entered into channel space 208, the liquid chemicals 114 may react as described herein to form foam material that expands from inner sheet 702 to contact and press surface sheets 214-1 and 214-2 against sizing elements 206-1 and 206-2, respectively. The expanded foam material may then cure and bond to inner sheet 702 and surface sheets 214-1 and 214-2 to form a product 110 having outer surface sheets 214-1 and 214-2 bonded to inner sheet 702 by a cured, rigid foam core that is bifurcated by inner sheet 702.

Similarly to inner sheet 702 being fed through sizing channel space 208 concurrently with surface sheets 214 and foam forming chemicals 114, one or other elements may be fed through sizing channel such that they may be disposed within surface sheets 214 in the product produced by a manufacturing process. As an example, one or more elements such as one or more wires, fiber glass rods, tubing, ribbon, aluminum rods, steel rods, etc. may be fed through channel space 208 such that the elements are included in the product produced by the manufacturing process. Such elements may be included in the product to add strength, rigidity, support, and/or other characteristics to the product. Additionally or alternatively, such elements may be included in the product to add functionality to the product. For instance, such as element may be used for connecting or otherwise mounting the product to a window covering assembly (e.g., to a ladder of a Venetian blind assembly).

While the above-described exemplary implementations describe sizing elements having flat surfaces configured to produce generally flat surfaces of product 110, in other implementations, one or more sizing elements may provide one or more non-flat surfaces of sizing channel space 208. For example, a sizing element may have one or more longitudinally disposed shapes configured to cause product to be produced (by foam material expanding to fill in sizing channel space 208 and curing to the shape of the sizing channel space 208) to have one or more longitudinal protrusions (e.g., ridges), recesses (e.g., valleys), or other non-flat surface features on a surface of the product. Accordingly, decorative and/or functional non-flat surface features may be produced on at least one of the bottom surface and top surface of product 110 such that at least one of the bottom surface and top surface of product 110 has a non-flat profile.

Additionally or alternatively, while sizing elements such as those described above may be generally stationary during a manufacture process, other embodiments of sizing elements may additionally or alternatively comprise moving parts such as rotating conveyer mechanisms configured to pull and/or push surface sheets 114 and/or product 110 through the sizing channel space formed by sizing elements. Such rotating conveyer mechanisms may be used as an alternative to or in addition to pulling rollers 210 or other feed mechanisms.

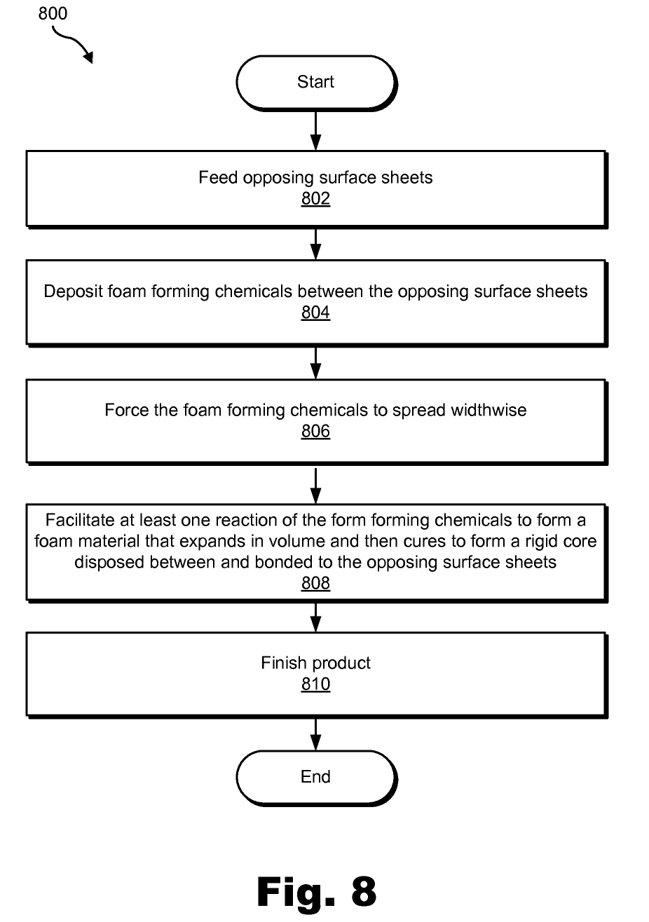

FIG. 8 illustrates an exemplary window covering component manufacturing method 800. While FIG. 8 illustrates exemplary steps according to one embodiment, other embodiments may omit, add to, reorder, combine, and/or modify any of the steps shown in FIG. 8. One or more steps of FIG. 8 may be performed by system 100 and/or any of the exemplary implementations of system 100 described herein, and/or by a user of system 100 and/or any of the exemplary implementations of system 100 described herein.

In step 802, opposing surface sheets are fed along a path that passes through a sizing channel space formed by opposing sizing elements. The opposing surface sheets may be fed in any of the ways described herein.

In step 804, foam forming chemicals (e.g., liquid chemicals 114) are deposited between the opposing surface sheets. The chemicals may be deposited in any of the ways described herein.

In step 806, the foam forming chemicals are forced to spread widthwise. The foam forming chemicals may be forced to spread widthwise in any of the ways described herein, such as by metering elements 202 forcing the chemicals to spread widthwise at metering channel space 204, for example. In certain alternative embodiments, step 806 may be integrated into step 804 or omitted from method 800 when the depositing of the chemicals in step 804 is performed in a way that allows the chemicals to be deposited at a predetermined width that is sufficiently wide for a manufacturing process.

In step 808, at least one reaction of the form forming chemicals is facilitated to form a foam material that expands in volume and then cures to form a rigid core disposed between and bonded to the opposing surface sheets. The reaction may be facilitated in any of the ways described herein (including by mixing chemicals 114 together, allowing time for a timed reaction to occur in the sizing channel space, and/or actively triggering the reaction by application of one or more other triggers), and the foam material may form, expand, and cure within sizing channel space 208 in any of the ways described herein to form a product such as product 110.

In step 810, the product may be finished. Step 810 may include performance of one or more finishing operations on the product. Examples of such finishing operations may include, without limitation, longitudinally cutting the product into longitudinal, elongate strips, cutting the strips to a desired length, attaching finished side edges to the strips, attaching finished end pieces to the longitudinal ends of the strips, attaching finished surfaces onto surface sheets 214 if surface sheets 214 do not already have finished surfaces, cutting holes or creating other openings for use in mounting the strips as slats to ladder supports in a blind assembly, painting the product, coating the product, vinyl wrapping the product, or any combination or sub-combination such finishing operations.

While the exemplary manufacturing processes described herein may be generally continuous processes, product 110 may additionally or alternatively be produced using one or more batch processes. For example, a batch of materials including foam forming chemicals and opposing surface sheets may be subjected to a manufacturing process that causes the foam forming chemicals to react to expand in volume to press against opposing surface sheets of a given batch size to form product 110 having a rigid foam core disposed between and bonded to the opposing surface sheets.

In any of the manufacturing processes described herein, sheets used in the process may comprise sheets of the same material or sheets of different materials. For example, an inner sheet may be made of the same of a different material than opposing surface sheets. As another example, two opposing surface sheets may be made of the same material or different materials.

In certain implementations, one or more of the principles described herein may be applied to manufacture a product from an allotted amount of foamable material determined by weight and volume. The allotted amount of foamable material may include or be formed from one or more ingredients that are either placed or applied between two opposing surface sheets in a way that allows for precise control of the foam material. A chemical reaction of the ingredients may be activated by one or more suitable triggers, such as those disclosed herein, such that the foam material grows to a precise thickness to fill a void and adhere to the opposing surface sheets. The foamed material may form a core disposed between and bonded to the opposing surface sheets, which may form a product that has an overall density (i.e., combined density of the foamed material core and the opposing surface sheets) of between two pounds per cubic foot and twenty-six pounds per cubic foot. In certain implementations, the product may be continuously produced at a rate between two feet per minute and two hundred feet per minute by either a batched or continuous method of manufacture.

In certain implementations, a product produced by a manufacturing method disclosed herein may be a window covering component that has a total overall density of less than approximately twenty-six pounds per cubic foot (26 lbs per ft³). In certain examples, the product may comprise a foamed core disposed between and bonded to opposing surface sheets. In certain examples, the product and may be suitable for use as a fully-finished window covering, such as a horizontal or vertical blind slat, louver, or shutter component.

In certain implementations, the product (e.g., a foamed cored disposed between and bonded to opposing surface sheets) may be produced to have a size that is no less than approximately 1.2 cubic inches of area (width multiplied by thickness) per lineal foot and is no greater than approximately one hundred cubic inches of area (width multiplied by thickness) per lineal foot.

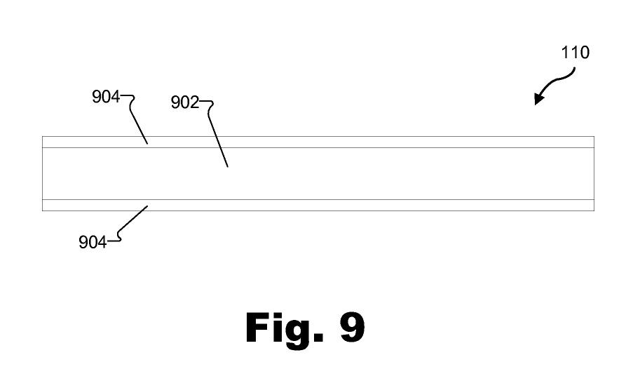

FIG. 9 illustrates a side view of a segment of an exemplary product 110 having a rigid foam core 902 disposed between and bonded to opposing surface sheets 904. Product 110 shown in FIG. 9 may be produced by any of the manufacturing processes described herein and may have any of the characteristics described herein.

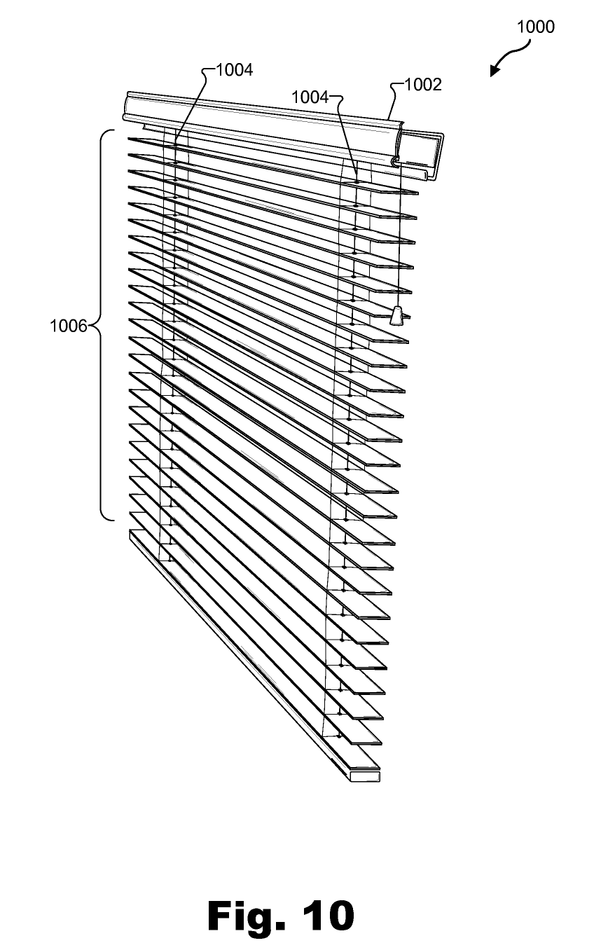

FIG. 10 illustrates an exemplary window covering apparatus 1000 incorporating window covering components manufactured in accordance with the principles described herein. As shown in FIG. 10, apparatus 1000 may include a headrail 1002, which may be configured to be fastened, through any suitable fastening mechanism (e.g., screws), to a structure proximate a window. Hence, headrail 1002 may support and provide stability to window covering 100. Ladders 1004 may be suspended from and hang vertically downward from headrail. Ladders 1004 may provide support and hold in place a plurality of horizontally-oriented slats 1006. Each slat 1006 may comprise product 110 manufactured in accordance with the principles described herein. Accordingly, slats 1006 may provide apparatus 100 with one or more advantages over conventional window coverings, including any of the benefits described herein.

While FIG. 10 illustrates an exemplary horizontal blinds window covering, window covering components manufactured in accordance with the principles described herein may be additionally or alternatively incorporated into other window coverings such as shutters and vertical blinds window coverings, for example.

Furthermore, while systems, methods, and apparatuses described herein are described in relation to window covering components, the principles described herein may be applied to manufacture products suitable for other uses. For example, the principles described herein may be applied to manufacture a generally flat stock product useful in construction applications (e.g., as building siding, shelving, cabinet parts, etc.) and/or commercial products (e.g., as rigid poster board).

One or more of the exemplary products described herein, manufactured in accordance with principles described herein, may be used as replacements for materials traditionally used in a variety of applications. For example, one or more of the products described herein may be suitable replacements for traditionally used plastic (e.g., PVC) or wood (e.g., lumber) materials.

The preceding description has been presented only to illustrate and describe exemplary embodiments with reference to the accompanying drawings. It will, however, be evident that various modifications and changes may be made thereto, and additional embodiments may be implemented, without departing from the scope of the invention as set forth in the claims that follow. The above description and accompanying drawings are accordingly to be regarded in an illustrative rather than a restrictive sense.

What is claimed is:

1. A window covering component manufacturing method comprising:
feeding two separate opposing surface sheets through a sizing channel space formed between opposing sizing elements;
depositing foam forming chemicals between the two separate opposing surface sheets before entry of the two separate opposing surface sheets into the sizing channel space; and
facilitating at least one reaction of the foam forming chemicals to form a foam material that expands in volume within the sizing channel space to press the two separate opposing surface sheets against the opposing sizing elements and then cures to form a rigid core disposed between and bonded to the two separate opposing surface sheets.

2. The method of claim 1, wherein the two separate opposing surface sheets form open side edges between the two separate opposing surface sheets within the sizing channel space.

3. The method of claim 2, wherein the rigid core is exposed by the open side edges.

4. The method of claim 1, wherein the two separate opposing surface sheets and the rigid core disposed between and bonded to the two separate opposing surface sheets form a planar product of sufficient width to be cut longitudinally into multiple window covering components.

5. The method of claim 4, wherein the two separate opposing surface sheets provide a finished bottom surface and a finished top surface of the planar product.

6. The method of claim 1, wherein the depositing comprises printing the foam forming chemicals onto a predetermined width of a surface of one of the two separate opposing surface sheets.

7. The method of claim 6, wherein the depositing further comprises printing the foam forming chemicals onto a predetermined width of a surface of the other one of the two separate opposing surface sheets.

8. The method of claim 7, wherein the printed surfaces face one another within the sizing channel space.

9. The method of claim 1, wherein:
the depositing comprises depositing a stream of the foam forming chemicals onto a surface of one of the two separate opposing surface sheets; and
the method further comprises forcing the deposited stream of the foam forming chemicals to spread widthwise before entry into the sizing channel space.

10. The method of claim 9, wherein the forcing of the deposited stream of the foam forming chemicals to spread widthwise comprises feeding the two separate opposing surface sheets with the foam forming chemicals disposed between the two separate opposing surface sheets through a metering channel space having a thickness configured to cause the foam forming chemicals to spread widthwise before entry into the sizing channel space.

11. The method of claim 10, wherein the foam forming chemicals are forced to spread to a width determined at least in part by the thickness of metering channel space, a rate at which the stream of the foam forming chemicals is deposited, and a rate at which the two separate opposing surface sheets are fed through the metering channel space.

12. The method of claim 1, further comprising:
feeding a separate inner sheet through the sizing channel space concurrently with the two separate opposing surface sheets, the separate inner sheet disposed between the two separate opposing surface sheets within the sizing channel space;
wherein
the depositing comprises depositing the foam forming chemicals onto two opposite surfaces of the inner sheet,
the at least one reaction comprises the foam forming chemicals on the two opposite surfaces of the inner sheet forming the foam material that expands in volume within the sizing channel space to press the two separate opposing surface sheets against the opposing sizing elements and then cures to form a rigid core disposed between and bonded to the two separate opposing surface sheets, and
the inner sheet bifurcates and is bonded to the rigid core.

13. The method of claim 1, wherein the two separate opposing surface sheets and the rigid core disposed between and bonded to the two separate opposing surface sheets form a planar product having an overall density within a range of two pounds per cubic foot to twenty-six pounds per cubic foot.

14. The method of claim 1, wherein the method is continuous and the two separate opposing surface sheets are fed through the sizing channel space at a rate within a range of two feet per minute to two hundred feet per minute.

15. The method of claim 1, wherein:
the foam forming chemicals comprise a catalyst and a polymer system determined by at least one of weight and volume; and
the two separate opposing surface sheets comprise one of paper, wood, wood veneers, and thermoplastic sheets.

16. The method of claim 1, wherein the facilitating of the at least one reaction of the foam forming chemicals comprises at least one of
allowing at least one timed reaction to begin within the sizing channel space, and
applying at least one of heat, cold, infrared light, ultraviolet light, moisture, friction, and an electron beam to the foam forming chemicals.

17. A window covering component manufacturing method comprising:
feeding two opposing surface sheets through a first channel space formed between a bottom metering element and a top metering element followed by a second channel space formed between a bottom sizing element and a top sizing element, the first channel space having a first thickness, the second channel space having a second thickness, the first thickness less than the second thickness;
depositing foam forming liquid chemicals between the two opposing surface sheets before entry of the two opposing surface sheets into the first channel space;
forcing the foam forming liquid chemicals to spread widthwise at the first channel space; and
facilitating a reaction of the foam forming liquid chemicals to form a foam material that expands in volume within the second channel space to press the opposing surface sheets against the bottom and top sizing elements and then cures to form a rigid core disposed between and bonded to the opposing surface sheets.

18. The method of claim 17, wherein the two separate opposing surface sheets and the rigid core disposed between and bonded to the two separate opposing surface sheets form a planar product having a thickness equal to the thickness of the second channel space and a predetermined width.

19. The method of claim 18, wherein the predetermined width is sufficient for the planar product to be cut longitudinally into multiple window covering components.

20. A window covering component manufacturing system comprising:
a spread assembly forming a first channel space having a first thickness;
a sizing assembly having two opposing sizing elements that form a second channel space having a second thickness, the first thickness less than the second thickness;
a feed assembly configured to continuously feed two opposing surface sheets through the first channel space and then the second channel space; and
a deposit assembly configured to continuously deposit foam forming liquid chemicals between the two opposing surface sheets before entry of the two opposing surface sheets into the first channel space;
wherein the thickness of the first channel space formed by the spread assembly is configured to force the foam forming liquid chemicals to spread widthwise at the first channel space as the two opposing surface sheets are fed through the first channel space;
wherein the foam forming liquid chemicals are configured to react to form a foam material that expands in volume within the second channel space to press the two opposing surface sheets against the opposing sizing elements and then cures to form a rigid core disposed between and bonded to the two separate opposing surface sheets.
